(19) United States
(12) Patent Application Publication
(10) Pub. No.: US 2002/0138472 A1
(43) Pub. Date: Sep. 26, 2002

(54) Method and system for an icon-driven interface to a database

(76) Inventor: John Ricciardi, London (GB)

Correspondence Address: RICHARD SAMUEL, ESQ., GOODWIN PROCTER LLP, 7 Becker Farm Road, Roseland, NJ, 07068-1757, US

(21) Appl. No.: 09/817,417

(22) Filed: Mar. 26, 2001

Related U.S. Application Data
(60) Provisional application No. 60/214,754, filed on Jun. 27, 2000.

(51) Int. Cl. G06F 7/00

(52) U.S. Cl. 707/3

(57) ABSTRACT

The present invention provides a unique icon-driven interface to a database that enables the construction and submission of a database query completely via icon display and selection. The invention involves displaying a plurality of icons to the user. The icons represent some database object such as a table, row, column or psuedo-structure. In constructing a database query, the user is spared the task of having to construct the query via typing or even selecting columns from table displays and operators such as “equals”, “not equals”, “greater than”, or “less than”. Rather, the user simply selects icons of interest to the user, then submits the constructed query. The user accomplishes this construction and submission without having to understand the database structures and/or data relations of the database. The benefits of the invention include enhanced user performance and more accurate database queries. The ease with which a database query can be constructed is dramatically improved. Moreover, since the user is not required to understand any of the inner workings of the database, the resultant query more frequently reflects accurately the information desired by the user. This makes the system easier to use by both novice and experienced users, and no matter what the skill level of the user, errors are eliminated as a result of the icon-driven technique which provides only the valid options for any database object within the database.

### RELATED UNITED STATES APPLICATIONS/CLAIM OF PRIORITY

This application is a non-provisional counterpart to, and claims the benefit of, co-pending U.S. Provisional Patent Application Ser. No. 60/214754, which was filed on Jun. 27, 2000 and entitled “Novel Web Site”. The entire disclosure of the forgoing patent application is incorporated by reference as if set forth at length herein.

### FIELD OF THE INVENTION

This invention generally relates to improvements in database query construction and submission, and more particularly to an icon-driven method and system for the construction and submission of database queries.

### BACKGROUND OF THE INVENTION

Databases have become one of the most significant areas of computing technology currently employed throughout the world. As the information age stretches into the next millenium, the importance of efficient and accurate information retrieval increases. Today, the volume of data being stored and retrieved by computerized databases is dramatically more than twenty years ago. Yet, the database query techniques available for use in retrieving all this information has been slow to progress.

Structured Query Language (SQL) has become a preferred language media for communicating queries to relational databases. As a consequence, there presently exist thousands of relational databases and thousands of related queries directed to such databases. Given the investment in such databases and queries, migration is not only a desirable feature but a substantially necessary capability for new relational database systems and methods.

The concept of portraying a query in a graphical depiction on a display screen of a workstation is a relatively new, but now widely available, approach to relational database interfacing. Visual queries, often referred to as graphical queries, utilize workstation graphics to represent query objectives heretofore defined by SQL statements. A visual query presents a pictorial depiction of the database tables and the data relationships amongst them, thereby eliminating any need for a user to learn a query language and improving the rate at which an SQL query can be constructed. However, even with the above-mentioned improvements, the user is still required to interpret and understand the often times intricate relationships between the many tables. This complexity frequently results in a rapidly constructed database query that yields unexpected results due to misconceptions of the data relationships by the user, thus increasing the error rate of database queries.

With the growing prevalence of relational databases, communication networks, web sites, and workstations (including portable network-accessing devices), the training and experience of a representative system user has decreased in relation to the resources available. The dilemma created by these various events is threefold. First, there exists an established and valuable base of queries formulated with classical SQL expressions. Second, there is a growing usage of relational databases and networks accessing their information. The end users of such databases are routinely less proficient in the very tools needed for efficient and accurate access to the relational database information. Finally, users of database access methods do not receive direct feedback of changes based on their manipulation of the database. Thus, there exists a distinct need for methods, systems and programs which go beyond the mere conversion of database query statements into visual representations of tables and data relationships, to the point where the database is completely represented by familiar icons available for selection by the user to construct a database query, thus completely eliminating the need for the user to understand the intricatcies of the inner workings of a database.

The impact of the limitations of current implementations of graphical query construction techniques is that, although less time is needed to construct a single query, often users end up recreating database queries again and again until the correct, desired database query is constructed because the prior attempts were inadvertently incorrect and led to inaccurate or no results.

### SUMMARY OF THE INVENTION

Accordingly, it is a primary object of the present invention to provide a unique method and system for an icon-driven interface to a database that enables the construction and submission of a database query via icon display and selection.

These and other objects of the present invention are accomplished through the simplification of the construction of a database query by the complete elimination of the need for the user to consider or understand the inner workings of a database. In the present invention, the construction of a database query is entirely accomplished through the selection of various graphically meaningful icons.

The benefits of the invention include enhanced user performance and more accurate database queries. The ease with which a database query can be constructed by a novice user is dramatically improved. Moreover, since the user is not required to understand any of the inner workings of the database, the resultant query always accurately reflects the information desired by the user. This makes the system easier to use by both novice and experienced users, and no matter what the skill level of the user, errors are eliminated as a result of the icon-driven technique which provides only the valid options for any object (i.e. tables, columns, rows, predicates, data relationships or dependencies, etc.) within the database.

In the present invention, the objects of the database are associated with their own meaningful icon. The objects of the database are the database structures such as the tables and elements within the structures. The icons are then displayed to the user for selection via a pointing device. The selections are dynamically formulated into a database query and applied against the relational database yielding the desired result. During the selection process, multiple layers of icons may be used to lead the user through the process. For example, the user may first be shown a series of icons that table structures within the inner workings of the database. For the user, however, these icons merely represent logical selection criteria without regard to any database structure (i.e. a clock icon may be associated with a table structure in the database but, to the user it means simply that he will have the opportunity to select certain time parameters).

In addition, certain icons can be displayed for psuedo-objects of the database, in other words, selection options that do not correspond to any concrete data structure within the database, but rather represent dynamically created selection criteria that look, feel and operate to the user in a manner as if they were an actual part of the database structures.

### BRIEF DESCRIPTION OF THE DRAWINGS

Exemplary embodiments of the present invention are now briefly described with reference to the following drawings:

FIG. 1 shows a sample of primary icons presented to a user for the purpose of constructing a database query and retrieving information from said database based upon said query.

FIG. 2 shows the same sample of primary icons as depicted in FIG. 1 along with a collection of second level icons that are presented to the user when the user selects one of the primary icons.

FIG. 3 shows the same sample of primary icons and second level icons as depicted in FIG. 2 along with a collection of third level icons that are presented to the user when the user selects one of the second level icons.

FIG. 4 shows another example of the presentation of second level icons when the user selects a different primary icon.

FIG. 5 shows a very simplistic, but representative sample of the type of database structures hidden from the user yet associated with the various icons available to the user for selection as part of a database query.

FIG. 6 shows a representative sample of the numerous icons accessible to the user and their association to a database object.

FIG. 7 shows one possible system setup whereby the user may access and utilize the preferred embodiment of the present invention.

### DETAILED DESCRIPTION OF PREFERRED EMBODIMENT

In the following detailed description of the preferred embodiment, reference is made to the accompanying drawings that form a part hereof, and in which is shown by way of illustration, a preferred embodiment in which the invention may be practiced. This preferred embodiment is described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense, and the scope of the present invention is defined only by the appended claims. The leading digit(s) of the reference numbers in the Figures usually correspond to the figure number, with the exception that identical components which appear in multiple figures are identified by the same reference numbers.

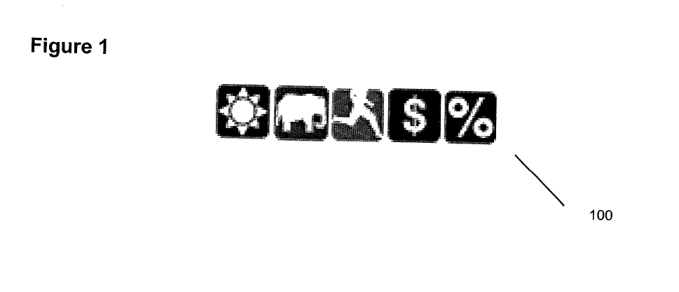

As shown in FIG. 1, a collection of first level icons 100 is presented to the user for selection when initiating the construction of a database query. As mentioned, FIG. 1 depicts only a reasonable sample of such icons. These first level icons 100 represent the highest level of selection criteria available for use in constructing a database query. Additionally, although not depicted, when the pointer is moved over top of any of the icons presented (regardless of the type or level of icon), the label of the icon may appear above, below or aside of the icon to further inform the user as to the representative meaning of the icon.

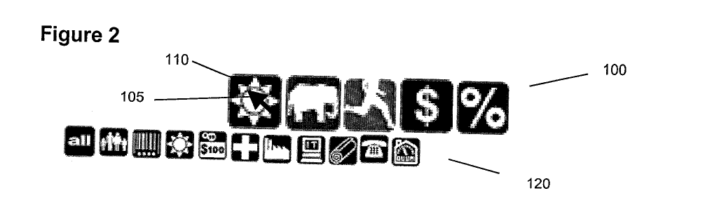

As shown in FIG. 2, a collection of second level icons 120 is presented to the user when the user selects or moves the pointer 105 over top of one of the first level icons. In FIG. 2, for example, the user has moved the pointer 105 onto the icon location designated for the selection options for sector groupings 110. Once activated, a second level of icons 120 representing the various sectors within the database appears below the first level icons. These second level icons 120 provide the user with a “drill down” selection method within any particular grouping of information.

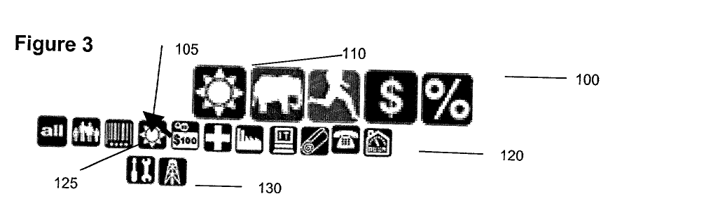

As shown in FIG. 3, a collection of third level icons 130 is presented to the user when the user selects or moves the pointer 105 over top of one of the second level icons 120. In FIG. 3, for example, the user has moved the pointer 105 onto the icon representing the energy sector 125 within the sector groupings. Once activated, a third level of icons 130 representing the various industries within the energy sector grouping within the database appears below the second level icons. These third level icons 130 provide the user with a further “drill down” selection method within any particular grouping of information.

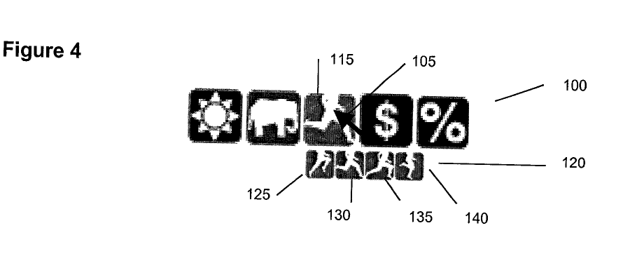

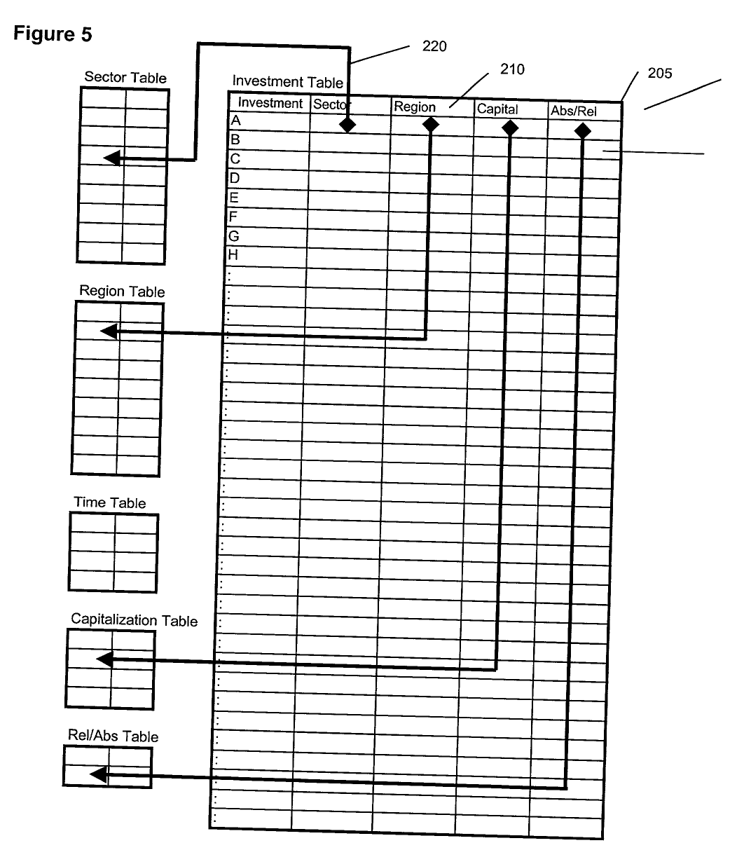

As shown in FIG. 4, the user is not limited to the selection of only one first level icon. Each first level icon is available to the user in order to construct the desired database query. In this figure, for example, the user has moved the pointer 105 over top of the icon location designated for the selection options regarding a time variable 115 for all historical information retrieved from the database. Once the time parameter first level icon 115 is activated by the user, a second level of icons 120 representing the different time parameters available for historical perspectives appear below the first level icons. In this figure, the four distinct time parameters (minutes 125, hours 130, days 135, and weeks 140) are represented by four icons, each depicting a runner at a different speed ranging from the slowest speed for weeks to the fastest speed for minutes. As shown in FIG. 5, in the preferred embodiment, the database structures 200 are tables 205 with columns 210 and rows 215 for storing database information. Various tables can have one or more relationships to numerous other tables within the database. These relationships 220 and the database tables 205 constitute a relational database scheme; however, other database schemes are equally possible. In addition, these tables 205, rows 215 and columns 210 (also referred to as database objects) can be associated with the various icons presented to the user in the process described above.

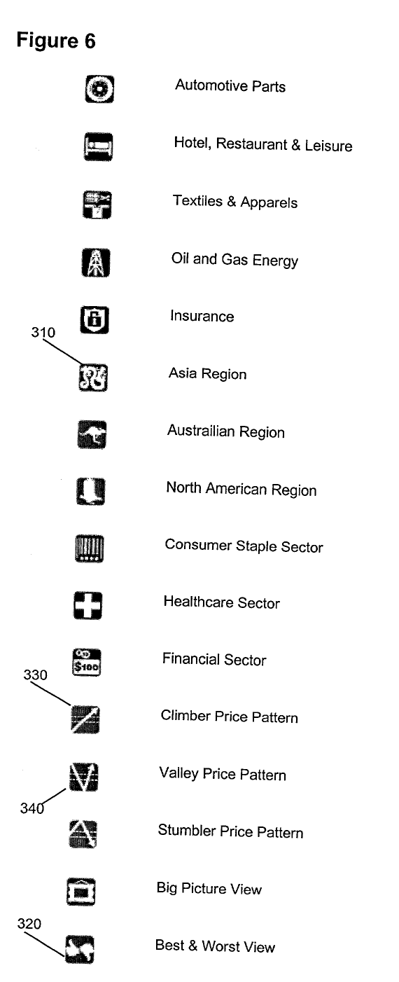

FIG. 6 is a representative sample of the types of associations made between the icons presented to the user for selection and the database objects present in the database scheme. For example, the one of the icons in FIG. 6 depicts a dragon 310 and is associated with the Asian region. Another example is last icon in FIG. 6 which depicts a “thumbs up/thumbs down” image 320, which is associated with a best and worst viewpoint available to the user. Each icon attempts to represent its logical association pictorially and thus eliminates further complexity for the user.

Additionally, the icons may represent, and be associated with, database objects of a psuedo-structure nature. What is meant by the term “psuedo-structure” is that certain database objects are not reflected in the database via a specific table, column or row. Rather these “psuedo-structures” are database objects which are derived through various calculations or comparisons between other database objects, or even between other database objects and one or more user-selected variables or parameters.

For example, within FIG. 6 is an icon associated with a specific price pattern. Each of these price pattern icons represent a different pattern that any given investment may have followed (i.e. can be plotted) over the course of the user-selected time parameter using a minimum of three plot points. An example of two such icons and associations within FIG. 6 are the climber price pattern 330 and the valley price pattern 340. The climber price pattern 330 represents an investment whose price continuously increased from plot point one through plot point two to plot point three. The valley price pattern 340 represents an investment whose price dropped dramatically from plot point one to plot point two, but then rose dramatically from plot point two to plot point three. When selecting one of these price pattern icons, the user incorporates into the database query the condition that all investment items which satisfy all other criteria designated by the user must also reflect the selected price pattern criteria as calculated under the user-designated time parameter.

In addition to the drawings discussed above which depict a small but representative sample of the preferred embodiment of the present invention, the preferred embodiment of the present invention can include numerous levels of icons for use in constructing a database query. The number of levels (and thus the depth to which a user may drill into the database) is likely proportional to the complexity of the underlying database. As the complexity of the underlying database increases, the number of levels to be traversed by the user also increases.

With regard to the sequence by which a user can select the various icons and thus construct and submit a database query, there is no pre-determined rule other than the user may submit the database query at any point. In effect, when the user first is presented with a first level of icons 100, those icons already indicate a “default” setting and the user can opt simply to retrieve the database information based upon those settings. For example, the default setting for the time parameter 115 previously discussed could be “daily” 125. The user can opt to maintain that setting and submit the database query or alter that default setting in the manner described above prior to submitting the database query. In any event, an entirely new query, using any or all of the prior query criteria, can be created simply by altering one or more of the settings—the user need not re-designate every criteria item desired for the search. This feature enables the user to easily refine the results of the prior query, or in other words, perform a search within the search.

Furthermore, not only can the user easily refine the results of a prior search, the icon-driven method of database query construction enables the user to rapidly alter the focus of the database query. In the present invention, a user can more easily modify the database query with a simple motion of resetting or changing any one or all of the parameters via the icons. For example, if the database results being displayed to the user include a price pattern icon parameter focusing the results on climbers, the user can switch that to valley price pattern simply by activating the appropriate icon. The user does not need to re-build the entire database query. Nor is the user required to edit the database query in any fashion. Moreover, once a database query has been constructed via the icon-driven database query method described above, the option exists to save the constructed query for recall and use later (during the same session or a subsequent session). This feature reduces further the need for the user to have any specific knowledge or understanding of the complex nature of underlying database.

With regard to the manner in which the user of the icon-driven method of database query construction would include the typical arithmetic-like expressions used within the typical database query construction method (i.e. equals, greater than, less than, etc.), it is important to understand that all of the icons available to the user for inclusion in a database query, by default contain, or can be considered to contain, an arithmetic expression. For example, when the user selects the icon of the dragon 310, which represents the Asian region, the user, through that selection, is directing the icon-driven database query interface to automatically, and behind the scenes, include the search criteria—“region=asia”.

Beyond the straightforward “equals to” expression, however, the present invention also has the capability to construct a database query that includes other types of arithmetic expressions. As just one example of such capability, the present invention includes a series of icons available to the user when constructing a database query relating to dividends. This series of icons denotes through their images—“high”, “medium”, “low”, or “none”. When the user selects, for example, the icon associated with “high” dividends, the user is directing the icon-driven database query interface to automatically, and behind the scenes, include the search criteria—dividends must be greater than or equal to the minimum value pre-determined for the “high” range for the dividend category, For example only, and without any meaning to the following number, if the minimum value for the “high” dividend category was set at 100, then the resultant search criteria would be “dividend>=100”.

With regard to the presentation of the various levels of icons to the user for use in constructing a database query via the present invention, it is important to understand that each icon available to the user in the first level has associated with it a predetermined hierarchical structure for its underlying levels. Thus, the number of levels of icons made available to the user will differ for each icon. However, that is not to say that any particular icon may not be available under a variety of sequences. In the present invention, a set of icons can be included, or nested, as an available level under different higher level icons.

For example, the set of icons associated with region may be made available to the user for selection within the first level of selectable icons. However, the same set of icons can be included as a sub-level of icons of the high level “macroeconomic rates” icon. The user's selection of a region (and possibly a particular country within that region via a subsequent icon selection level) could have a different meaning and yeild different search criteria than the selection of a region from the first level region icon.

It is equally important to comprehend the notion that these sets of icons presented to the user function not only as a type of navigation tool by which the user drills into the underlying database, but also as a source of information when results of a database query are returned. For example, once a database query has been constructed and submitted, the results are displayed to the user. However, as described above, the user has the ability to “drill down” into the results in order to hone in on any information of particular interest to the user. As described above, one such manner to accomplish this “drill down” technique is to available to the user is through further selection of icons. So in order to assist the user, sets of icons may include, for example, statistical information driven by the results of the database query.

One specific example of this would be the set of icons described above for price patterns. Once the user has constructed and submitted a database query, the user may wish to focus only on information relevant to a particular price pattern. When reviewing the set of price pattern icons, the number and relative percentage of resulting records that fall within each such price pattern may be displayed near to each such price pattern icon, thus providing the user with even greater information than simply the database query result and acting as more than a mere navigational tool.

Another example of how the sets of icons may act as more than a navigational tool relates to a capability within the present invention to override the default order of displayed results. In essence, the present invention includes the capability to restructure the order of the results based upon certain icons associated with ranking criteria for each resultant record. For example, once the list of records that qualifies under the user's database query submission is displayed to the user, the user may wish to hone in on a particular subsection of the information based upon certain macroeconomic information such as earnings, valuations, capitalization, or some combination. In the present invention, the user can accomplish that task simply through the same icon selection technique used to select the other desired database query criteria.

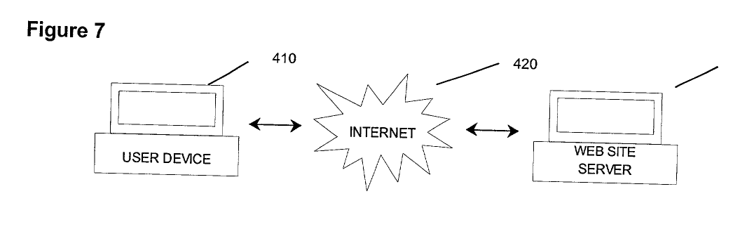

Finally, with regard to the preferred embodiment for the manner and method through which the present invention is accessed and utilized by a user, FIG. 7 depicts one representative sample of such a method and manner. As shown in FIG. 7, the access and use of the present invention can be by way of a user device 410, having a computer processor and associated memory, being connected to a computer network, and that communicates across the computer network 420 with a web site server 430 (also connected to the computer network), with its own computer processor and associated memory.

The web site server 430 and the user device 410 preferably both include a programmable computer with a computer processor, associated memory, a storage medium readable by the computer processor (including volatile and non-volatile memory and/or storage elements), at least one input device and one or more output devices. Preferably, the web site server 430 and user device 410 can be a personal computer system such as an IBM PC or IBM PC compatible system or an APPLE MacIntosh system or a more advanced computer system, although mainframe computer systems or any other internet-accessing device can also be used. Also, preferably, the computer network 420 is a global TCP/IP based network such as the Internet or an intranet, although almost any well known LAN, MAN, WAN, or VPN technology can be used.

In the preferred embodiment, the web site server 430 is adapted to transfer and receive information over the computer network 420. It is also adapted to store information in, and retrieve information from its associated memory, as well as perform comparisons and calculations of information. Furthermore, the web site 430 server may be adapted to modify information associated with and located on the user device 410.

The user device 410 is adapted to transfer and receive information across the computer network 420. In the preferred embodiment, the user device 410 is operated by a user. A user can be a human being, a process or node acting as if it were a human being or a physical object programmed to act like a human being.

Moreover, although the web site server 430 and user device 410 are described in the context of a single web server, one of ordinary skill in the art will appreciate that the described functionality may be implemented across multiple servers.

Further still, with regard to implementation of the present invention, the present invention may be implemented in hardware or software, or a combination of the two. Preferably, the present invention is implemented in computer programs executing on the above-mentioned computer processor associated with the above-mentioned programmable computer. Program code is applied to data entered using the input device to perform the functions described and to generate output information. The output information is applied to one or more output devices. The term “input device” refers to any device or technique that accomplishes the transmission of input to the computer processor, including, but not limited to, such devices or techniques as a computer keyboard, keypad, touch screen, and voice recognition.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.Having now described the preferred embodiment of the present invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, equivalents or similar purpose, unless expressly stated otherwise. Therefore, numerous other embodiments of the modifications thereof are contemplated as falling within the scope of the present invention as defined by the appended claims and equivalents thereto.

What is claimed is:

1. A method for a user to construct a database query, comprising the steps of:
displaying a first plurality of icons at said computer, each of said first plurality of icons being associated with at least one database object;
selecting at least one of said first plurality of icons; and
transforming said selection of icons into a database query.

2. A method according to claim 1 further comprising the step of retrieving information from said database in response to said database query.

3. A method according to claim 2 further comprising the step of displaying said retrieved information to said user.

4. A method according to claim 1 wherein said database is of a type chosen from the group consisting of relational, object-oriented, and object-relational.

5. A method according to claim 1 wherein said database query is SQL-compliant.

6. A method according to claim 1 further including a step for displaying a second plurality of icons in response to said selection of at least one of said first plurality of icons, each of said second plurality of icons being associated with at least one said database object.

7. A method according to claim 6 further including a step for selecting at least one of said second plurality of icons.

8. A method according to claim 7 further including a step for transforming said selection of icons from said second plurality of icons into part of said database query.

9. A method according to claim 1 further including a step for displaying a textual label for each said icon.

10. A method according to claim 1 further including a step for displaying a numeric value associated with each said icon.

11. A method according to claim 1 wherein said database objects are stored in said database.

12. A method according to claim 11 wherein said database objects are accessible by said user.

13. A system for constructing a database query comprising:
a central processing unit;
a database having information, said database associated with said central processing unit;
a display device associated with said central processing unit;
an input device associated with said central processing unit;
a computer-readable program module associated with said central processing unit, said program module being adapted for
displaying a first plurality of icons at said computer, each of said first plurality of icons being associated with at least one database object;
selecting at least one of said first plurality of icons; and
transforming said selection of icons into a database query.

14. A system according to claim 13 wherein said program module is adapted further for retrieving information from said database in response to said database query.

15. A system according to claim 14 wherein said program module is adapted further for displaying said retrieved information on said display device.

16. A system according to claim 13 wherein said database if of a type chosen from the group consisting of relational, object-oriented, and object-relational.

17. A system according to claim 14 wherein said database query is SQL-compliant.

18. A system according to claim 14 wherein said program module is adapted for displaying a textual label for each said icon.

19. A system according to claim 14 wherein said program module is adapted for displaying a numeric value for each said icon.

20. A system according to claim 14 wherein said program module is adapted for displaying a second plurality of icons in response to the said selection of at least one of said first plurality of icons, each of said second plurality of icons being associated with at least one said database object.

21. A system according to claim 20 wherein said program module is adapted further for selecting at least one of said second plurality of icons.

22. A system according to claim 13 wherein said database objects are stored in said database.

23. A system according to claim 22 wherein said database objects are accessible by said user.
